(19) United States
(12) Patent Application Publication
(10) Pub. No.: US 2024/0256903 A1
(43) Pub. Date: Aug. 1, 2024

(54) SYSTEMS AND METHODS FOR USING MACHINE LEARNING AS A SEGMENTATION TOOL

(71) Applicant: THE TORONTO-DOMINION BANK, TORONTO (CA)

(72) Inventors: TRAVIS ADRIAN ENS, TORONTO (CA); MICHAEL CRISTEA, TORONTO (CA); ZIZHUANG TANG, RICHMOND HILL (CA); MAHDI GHELICHI, TORONTO (CA)

(21) Appl. No.: 18/374,126

(22) Filed: Sep. 28, 2023

Related U.S. Application Data
(60) Provisional application No. 63/441,373, filed on Jan. 26, 2023.

(51) Int. Cl. G06N 5/01; G06N 20/00

(52) U.S. Cl. CPC G06N 5/01; G06N 20/00

(57) ABSTRACT

Various examples are directed to providing segmentation tools using machine learning for executable decision tree generation on graphical user interfaces. For example, a system may generate a segmentation tool for receiving input data from a server including data related to a plurality of attributes of a set of records. The segmentation tool then generates a segmentation user interface for receiving input for parameters relating to features of interest and defined decision tree characteristics for generation of a decision tree having a set of nodes. The segmentation tool may further apply a machine learning model to generate an optimal decision tree based on the input data and the set of parameters. The segmentation tool may further extract a set of statistics related to the optimal decision tree including efficacy graphs and provide for presentation an interactive graphical interface concurrently depicting the optimal decision tree and the set of statistics.

### CROSS-REFERENCE TO RELATED APPLICATIONS

This application claims priority from U.S. Provisional Patent Application No. 63/441,373 Filed Jan. 26, 2023, and entitled “MACHINE LEARNING AS A SEGMENTATION TOOL”; the entire contents of which are hereby incorporated by reference herein.

### FIELD

The present disclosure relates to computerized machine learning based systems and methods for generating an interactive and dynamic computerized segmentation tool.

### BACKGROUND

Assessment and prediction of a data feature in complex and large data sets using stale data or manual decision trees is a strategy employed by institutions in order to facilitate the making of subsequent actions or decisions. The programs and computer technologies currently employed, however, require manual intervention and lack the dynamic aspect of handling real time data.

The tools lack the capability to efficiently and accurately create optimized, customizable and interactive executable decision trees and associated user interfaces.

### SUMMARY

Creating decision trees by manually and “blindly” inputting various criteria for generating the decision tree without knowledge on how best to optimize the decision trees yields suboptimal decision trees which lack usefulness and accuracy and thereby lack user engagement.

The creation of accurate, reliable, and optimized real-time and dynamically generated decision trees is exceedingly difficult and typically relies on the experience and capabilities of the individual(s) creating them. This can lead to inaccuracies and inefficiencies as the individual(s) may not be aware of or consider using all the important attributes available to them to make the tree, and often have to make judgement calls on the importance of attributes and their decision thresholds in order to make each split. This approach is tedious, wastes computing resources and yields inaccurate and unpredictable results.

There is therefore a need in at least some implementations to ensure a computerized and executable decision tree created is the most optimized tree which utilizes dynamic and real-time data by allowing user interface exploration of various features and scenarios of the executable decision tree using a segmentation tool user interface that can best aid in the generation of the executable decision tree and associated decisions.

In at least some implementations, the present method and system provides an improved user interface and computerized segmentation tool which allows dynamic interaction directly with an executable decision tree to explore various generation decision criteria of the tree, allows exploration of various statistics and hidden features on the effectiveness of various attributes and features of the decision tree generated, allows automatic and/or semi-automatic and/or user defined inputs based on the explored criteria to manipulate and regenerate the executable decision tree based on the inputs such as but not limited to: how each decision node should be split, including based on what population size, on what attributes, and using which decision tree algorithms such as to generate an optimized decision tree on the user interface with associated statistics of generation.

Existing systems which deal with stale data and manual input of all decision tree characteristics, leave room for significant errors in the end decision tree.

The proposed systems provide, in at least some aspects, an interactive digital user interface for segmentation using machine learning via a segmentation tool; ensure all possible (or at least important) attributes have been considered for generation of the executable decision tree, verify whether the tree created is the most optimized, assess the risks associated with the various leaves of the decision tree and efficiently adjust the tree after it is created as well as allow interactive manipulations of the tree and its nodes.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computerized method of interactive segmentation analysis. The computerized method also includes receiving input data from a server, the input data may include data points related to a plurality of attributes of a set of records; generating a user interface on a computer device configured to receive input for a set of parameters related to a generation of a decision tree containing a set of nodes, the set of parameters may include: a computerized algorithm to employ in creating the decision tree; constraints pertaining to the algorithm selected may include selecting the maximum number of leaf nodes if leaf-wise is selected, or selecting the maximum depth if depth-wise is selected; a minimum number of records to be divided into each node of the decision tree; and a set of attributes for consideration by the decision tree from the plurality of attributes contained in the input data. The method also includes generating, using a machine learning model, an optimal decision tree containing a plurality of nodes based on the input data and the set of parameters; extracting a set of statistics related to the optimal decision tree, where the set of statistics may include information pertaining to the plurality of nodes of the optimal decision tree and indicative of reasoning for generation of the optimal decision tree and associated efficacy metrics for each of the attributes considered; and providing, for presentation on the user interface, an interactive graphical interface concurrently depicting the optimal decision tree and the set of statistics. Other embodiments of this aspect include corresponding computer systems, apparatus, and computer programs recorded on one or more computer storage devices, each configured to perform the actions of the methods.

Implementations may include one or more of the following features. In one aspect, the algorithm may include at least one of: a tree growth model, depth-wise, and leaf-wise tree generation modes. In one aspect, the optimal decision tree presented on the graphical interface is further configured to receive inputs from a user to alter the optimal decision tree presented on the graphical interface. In one aspect, the inputs to alter the optimal decision tree on the graphical interface may include user interface requests received directly on the decision tree nodes generated on the user interface to combine sub-nodes of a node within the optimal decision tree presented on the graphical interface, via regeneration of the optimal decision tree by the machine learning model. In one aspect, the inputs to alter the optimal decision tree presented on the graphical interface may include user interface requests to alter a manner in which a particular node of the optimal decision tree divides into its sub-nodes, via regeneration of the optimal decision tree by the machine learning model. In one aspect, the inputs to alter presentation of the particular node of the optimal decision tree on the graphical interface divides into its sub-nodes includes altering the number of samples divided into each of the sub-nodes via regeneration of the optimal decision tree by the machine learning model. In one aspect, the inputs to alter the optimal decision tree on the graphical interface may include a user interface menu to allow custom splitting of a selected node of the optimal decision tree to create two new leaf nodes from the selected node which then represents an internal node. In one aspect, the input to alter the optimal decision tree on the graphical interface further may include a user interface menu to graft a first tree onto a second tree via selection and dragging one tree displayed on the user interface onto another thereby causing regeneration of the optimal decision tree including the first and the second tree. In one aspect, the machine learning model is a supervised machine learning model trained on a set of known outcomes and known attributes to generate the optimized decision tree from the set of parameters. In one aspect, the machine learning model is an xGBoost (extreme gradient boosting) model. Implementations of the described techniques may include hardware, a method or process, or computer software on a computer-accessible medium.

One general aspect includes a system which may include a computer having at least one processor and a non-transient storage medium storing computer readable instructions. The system also includes receiving input data from a server, the input data may include data points related to a plurality of attributes of a set of records; generating a user interface on a computer device configured to receive input for a set of parameters related to a generation of a decision tree containing a set of nodes, the set of parameters may include: a computerized algorithm to employ in creating the decision tree; constraints pertaining to the algorithm selected may include selecting the maximum number of leaf nodes if leaf-wise is selected, or selecting the maximum depth if depth-wise is selected; a minimum number of records to be divided into each node of the decision tree; and a set of attributes for consideration by the decision tree from the plurality of attributes contained in the input data. The system also includes generating, using a machine learning model, an optimal decision tree containing a plurality of nodes based on the input data and the set of parameters; extracting a set of statistics related to the optimal decision tree, where the set of statistics may include information pertaining to the plurality of nodes of the optimal decision tree and indicative of reasoning for generation of the optimal decision tree and associated efficacy metrics for each of the attributes considered; and providing, for presentation on the user interface, an interactive graphical interface concurrently depicting the optimal decision tree and the set of statistics. Other embodiments of this aspect include corresponding computer systems, apparatus, and computer programs recorded on one or more computer storage devices, each configured to perform the actions of the methods.

In at least one aspect, there is provided a non-transitory machine-readable medium comprising instruction thereon that, when executed by a processor unit, causes the processor unit to perform operations described herein.

### BRIEF DESCRIPTION OF THE DRAWINGS

These and other features will become more apparent from the following description in which reference is made to the appended drawings wherein:

FIG. 1 is a schematic diagram illustrating one example of a computing environment for implementing computerized segmentation tools using machine learning in accordance with one or more aspects of the present disclosure.

FIG. 2 is a screen shot showing an example screen (or portion of a screen) for the segmentation tool user interface for selecting and inputting parameters for generating a decision tree model in accordance with one or more aspects of the present disclosure.

FIG. 3 is a screen shot showing another example screen (or portion of a screen) showing an example generated decision tree by the segmentation tool user interface in accordance with one or more aspects of the present disclosure.

FIG. 4 is a screen shot showing another example screen (or portion of a screen) showing example parameters from the generated decision tree provided by the segmentation tool user interface in accordance with one or more aspects of the present disclosure.

FIG. 5 is a screen shot showing an example screen (or portion of a screen) for the segmentation tool user interface with a portion of the decision tree displayed showing the visually differentiation markers for the different nodes in accordance with one or more aspects of the present disclosure.

FIGS. 6, 7A and 7B are example screen shots showing example screens (or portions of a screen) for the segmentation tool user interface displaying various additional graphs and information generated in relation to the generated decision tree in accordance with one or more aspects of the present disclosure.

FIGS. 8A-8C are screen shots showing example screens (or portion of a screen) for the segmentation tool user interface indicating example user interface input manipulations available with the segmentation tool for selecting and manipulating user interface elements of the decision tree displayed in accordance with one or more aspects of the present disclosure.

FIG. 9 is a flowchart showing one example of a process flow that may be executed by the segmentation engine in accordance with one or more aspects of the present disclosure.

FIG. 10 is a block diagram illustrating one example of architecture for a computing device for implementing the segmentation engine of FIG. 1 in accordance with one or more aspects of the present disclosure.

### DETAILED DESCRIPTION

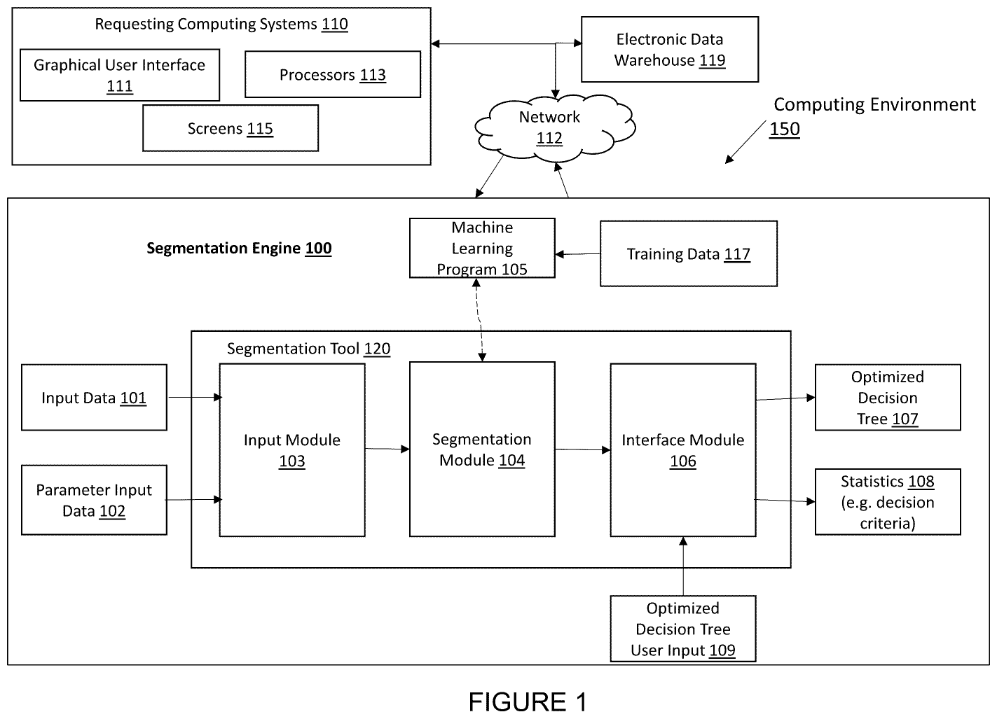

In at least some implementations, there is provided a computerized tool, method and system shown as the computing environment 150 in FIG. 1 that efficiently creates and visually displays on a computer user interface (e.g. shown as a graphical user interface 111 having one or more screens 115 of one or more requesting computing systems 110 having associated processors 113), accurate and optimized executable decision trees (e.g. optimized decision tree 107), including the attributes selected to be of interest and the population sizes (e.g. shown as statistics 108) based on a holistic approach of examining relevance of various attributes and features of the input data 101 and the generated decision tree 107 using the user interface 111 via a segmentation engine 100. In the computing environment 150, the requesting computing systems 110 communicate across a network 112 with a segmentation engine 100 configured to generate a dynamic and amendable executable decision tree 107 for display on a user interface, such as the graphical user interface 111 having screens 115.

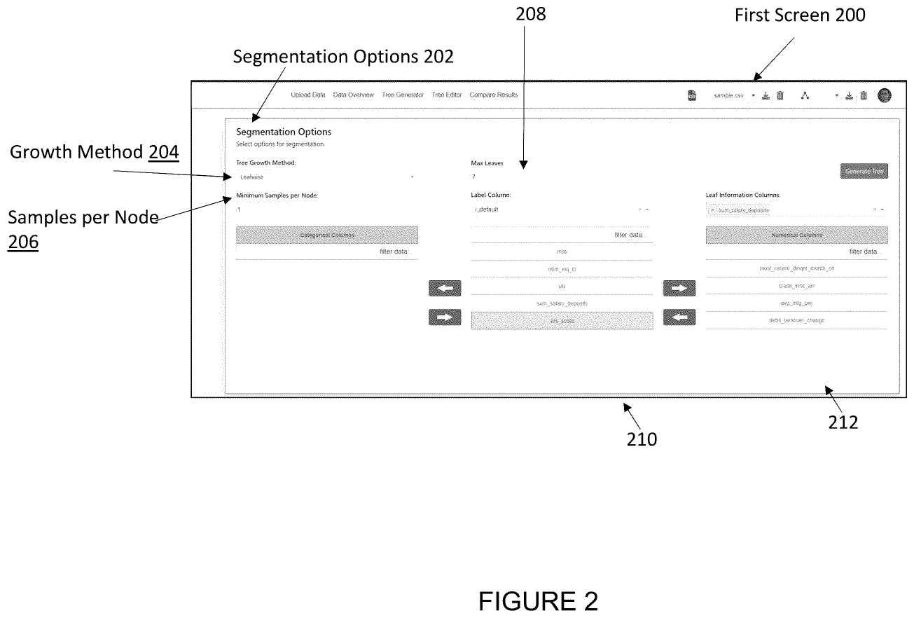

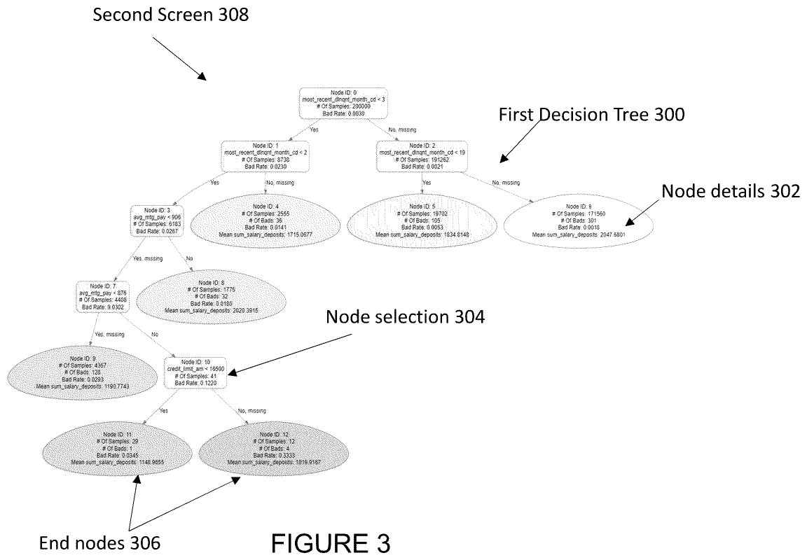

In at least some implementation and referring to FIGS. 1-10, a computer-implemented system, method and segmentation engine 100 generates a user interface for developing, managing, maintaining, manipulating and updating an optimized executable decision tree (e.g. the optimized decision tree 107) having visually selectable and changeable nodes and decision thresholds and along with visually displayed set of interactive and modifiable characteristics such as but not limited to: defining the criteria for the decision tree generated, decision tree generation algorithms applied, effectiveness of each attribute relative to other attributes for generation of the decision tree, etc. An example screen (e.g. first screen 200) of the user interface providing segmentation options and decision tree parameters (e.g. segmentation options 202 such as for receiving input data 101 and parameter input data 102) for input to the computerized segmentation tool 120 for generating the decision tree, such as the decision tree shown as a first decision tree 300 in FIG. 3 for display on the user interface which displays a logical outline or set of rules and results associated with the decisions made at each stage of the decision tree and associated characteristics. As shown in FIG. 2, the first screen 200 may also display in the segmentation options 202, selectable and inputtable user interface fields such as growth method 204 (e.g. for selecting depth wise or leaf-wise method); minimum samples per node 206; maximum leaves 208 for the maximum number of leaves on the output tree, a set of available attributes 210; and a set of selected attributes 212 for generating the output decision tree 107 of FIG. 1.

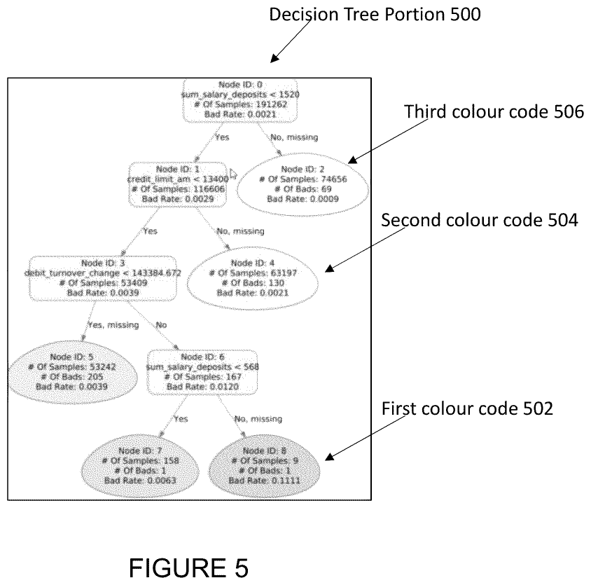

In at least some aspects, referring to FIGS. 1-4, the segmentation engine 100 is capable of providing visual digital information (e.g. statistics and decision criteria shown as optimized decision tree 107 and statistics 108) about the relative importance of the attributes and the risk associated with each leaf or decision node (e.g. see node details 302 in FIG. 3 which may be displayed on each node of the decision tree describing each node, number of samples, # of bads, bad rate, and average sum of values; see also node characteristics 402 shown on a node table 400 displayed on a screen, e.g. the third screen 404 of the user interface of the segmentation tool 120 including characteristics such as the feature name, split, missing direction, etc. which can be selected for editing such as to modify one feature with a different feature). Referring to FIGS. 3 and 5, in FIG. 5 is shown a portion of a decision tree as generated on a portion of the user interface by the segmentation tool 120 and there is illustrated how the segmentation tool 120 is further configured to generate the decision tree 107 such as to visually differentiate between values of features easily. As shown in FIGS. 3 and 5, in this specific example, colour coding is applied to show various values for a particular feature, e.g. the “bad” rate or the likelihood or proportion of accounts or data records which have defaulted or failed to meet a set of requirement. In this case, three different colour codes are used, namely, a first colour code 502, a second colour code 504 and a third colour 506 to visually differentiate and easily portray various levels of values for a particular feature explored in a given node, e.g. the “bad rate”.

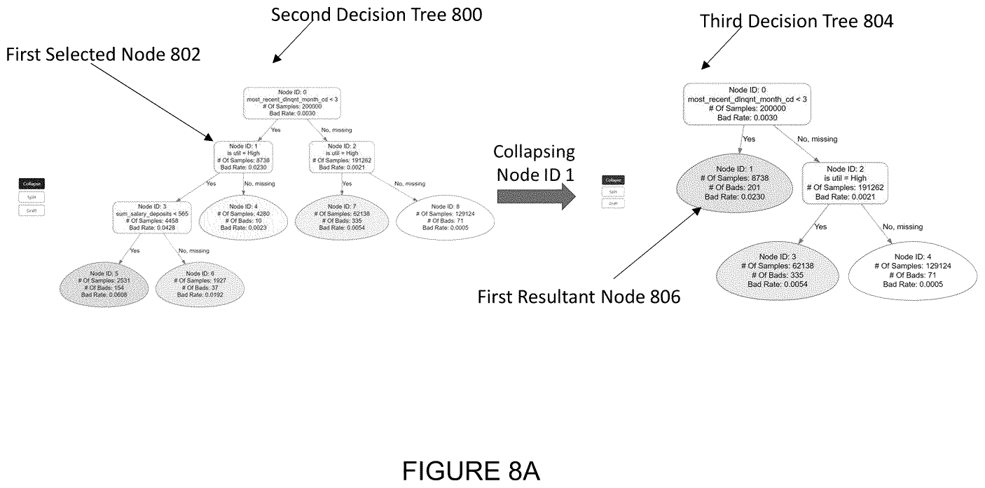

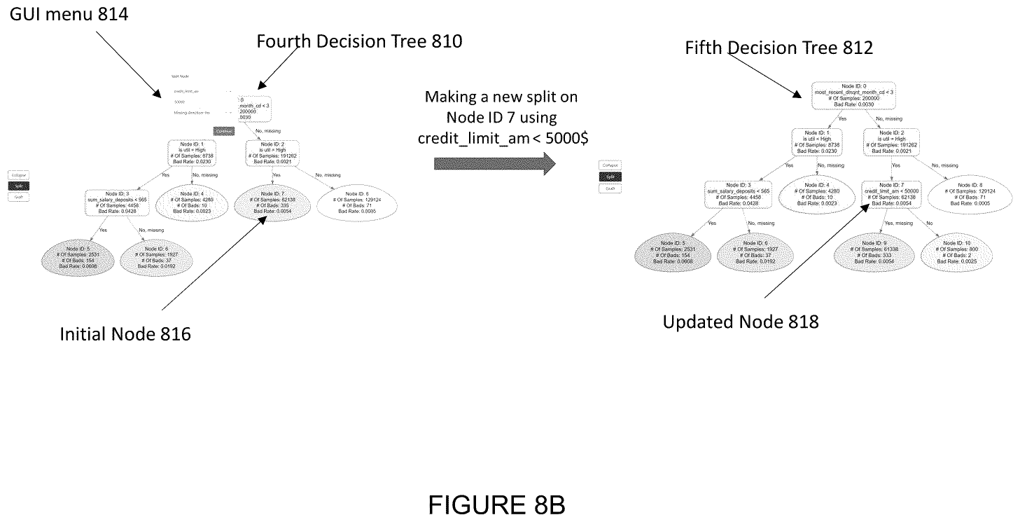

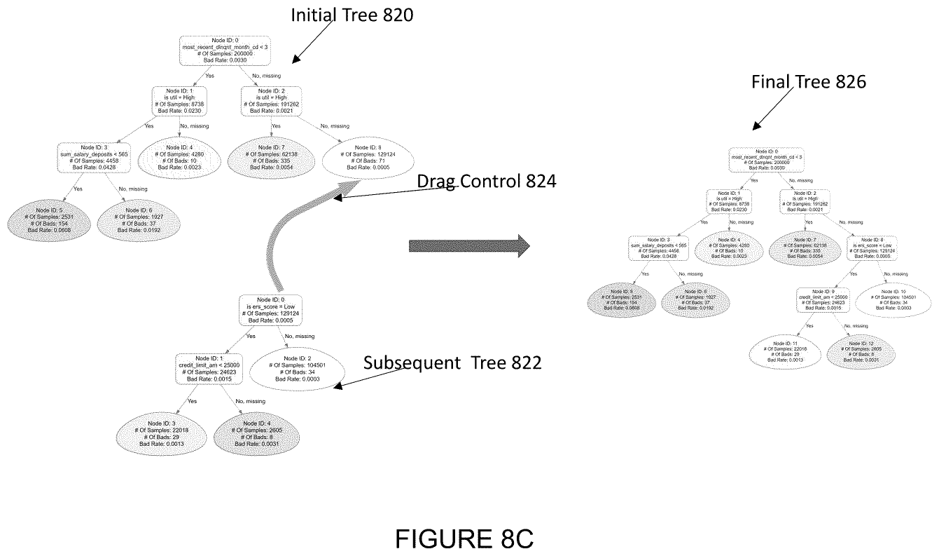

In addition, in at least some aspects and referring to FIGS. 1-10, the computerized tool provided by the segmentation engine 100 allows for the amendment and manipulation to the visually displayed executable decision tree (e.g. optimized decision tree 107 such as via selecting, dragging and/or dropping nodes, combining nodes, modifying thresholds for splitting nodes, right clicking on nodes to open a menu to manipulate the node, adjusting a node to combine with the root nodes) after it is created. For example such user interface manipulations of the optimized decision tree 107 may further include UI input such as via optimized decision tree user input 109. This may include selection of a particular node on the optimized decision tree 107 causing the collapsing of its end or leaf or decision nodes. An example of such a selection and manipulation received on the user interface of the segmentation tool 120 is illustrated in FIG. 8A, whereby selection of a first selected node 802 on a second decision tree and requesting a collapse of said node on the user interface, cause the first selected node 802 to collapse all of the associated nodes further down the decision tree (e.g. leaf and/or internal decision nodes) into the first selected node 802 to result in the third decision tree 804 having the first resultant node 806 containing all of the node characteristics of the nodes dependent upon (e.g. further down on the tree) from the first selected node 802.

In yet another aspect, another example of manipulation of the optimized decision tree 107 shown as optimized decision tree user input 109 in FIG. 1 via user input on the UI elements for the segmentation tool 120 is illustrated in FIG. 8B whereby selection of an initial node 816 causes generation of a GUI menu 814 which allows creation of customized node splits and thresholds. In the example of FIG. 8B, the input on the GUI causes a new split using the new thresholds.

In yet another aspect, another example of manipulation of the optimized decision tree 107 shown as optimized decision tree user input 109 in FIG. 1 via user input on the UI elements for the segmentation tool 120 is illustrated in FIG. 8C whereby selection of an initial tree 820 for display and then subsequent selection of a second subsequent tree 822 and dragging same on the user interface to the first tree using the drag control 824 causes the segmentation tool 120 to regenerate the optimized decision tree 107 by combining both trees such as to graft or attach one tree to another to generate the final tree 826 displayed in the example of FIG. 8C.

Such example manipulations received on the user interface of the segmentation tool 120 conveniently assist to increase the efficiency of the computer in creating the interactive and customizable executable decision trees for performing subsequent actions based on the results. In at least some implementations, it is also desirable for this computer tool, shown as the segmentation engine 100 to be interactive and responsive to user input to update and revise the decision trees for segmentation such as via optimized decision tree user input 109.

As will be described, conveniently, in at least some aspects, the segmentation engine 100 of FIG. 1 generates a segmentation tool 120 for presentation and use via an associated user interface, e.g. the graphical user interface 111, accessing across a network 112, which facilitates uploading the input data and in some aspects, parameters of interest thereby allowing generation and growth of an executable decision tree using a machine learning program, e.g. the optimized decision tree 107 in a very automated way which allows customization of the decision tree based on pre-defined and/or input preferences and testing of the decision tree efficacy via display of the various decision tree efficiency metrics and associated visual graph as generated for interactive display via the statistics 108 concurrently on the user interface.

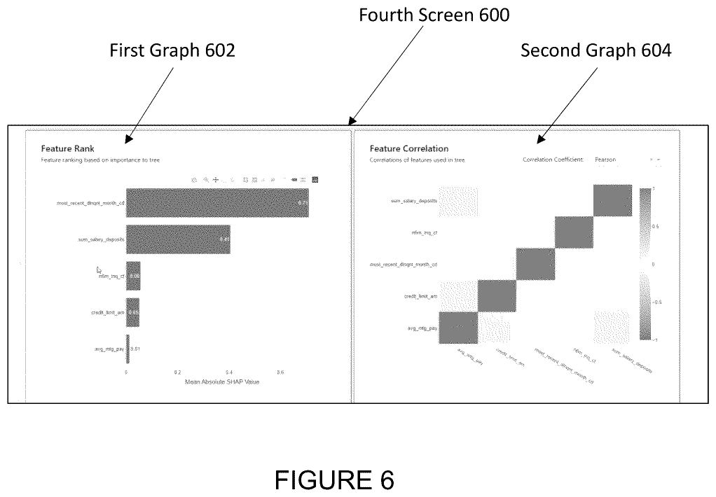

Examples of statistics 108 of FIG. 1 which may include various efficacy metrics for the generated optimized decision tree 107 including testing results for testing how various attributes compare to one another in formulating the decision tree, feature ranking and feature correlation are illustrated in FIG. 6 shown on a fourth screen 600 of the segmentation tool 120 illustrated features ranked in order of importance and contribution to the decision tree in a first graph 602 and feature correlation in a second graph 604. Other metrics or graphs displayed may include for example a feature heat map illustrating correlation of various features and associated values. That is, the machine learning program 105 of FIG. 1 generates a feature importance ranking measuring the contribution of each feature or variable input to the model for generating the executable decision tree. As illustrated, the higher the value, the more important the feature in the first graph 602. Similarly second graph 604 further displays performance metrics for the executable decision tree which illustrates a correlation matrix showing the correlation between all possible pairs of variables in the input dataset. Conveniently, such visualizations of efficacy metrics and performance evaluations generated by the segmentation engine 100 on the user interface of the segmentation tool 120 in a single view (e.g. the fourth screen 600 may be a scrolled down view(s) of the screens illustrated in FIGS. 2-4 thereby allowing a simultaneous viewing of the executable decision tree and efficacy metrics) allows examining the efficacy of all of the attributes from which the decision tree has been generated in an explainable and faster manner such as to allow ease of determination of the accuracy of the executable decision tree generated and allow amendments to the input parameters (e.g. features considered by the decision tree) such as to allow automatic improvement of the decision tree in subsequent iterations.

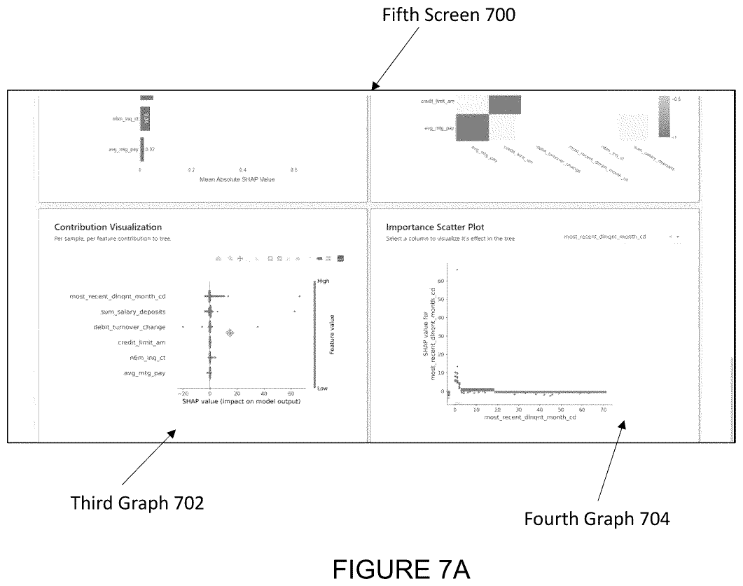

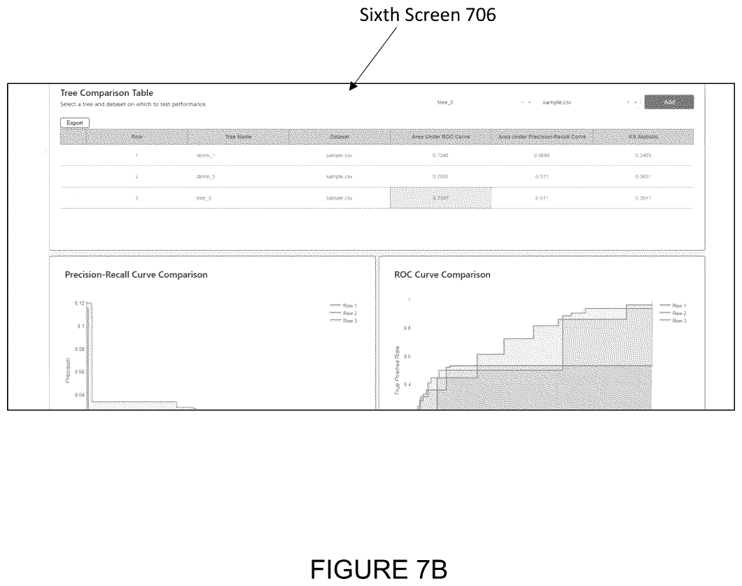

Other examples of visualizations of efficacy metrics and performance evaluations for each of the features in the decision tree 107 of FIG. 1 is shown in the snapshot view of a fifth screen 700 of FIG. 7A illustrating a portion of a screen showing concurrently a third graph 702 illustrating contribution visualizations and a fourth graph 704 illustrating an importance scatter plot illustrating the effect of each feature and associate values which may be displayed concurrently along with the displayed visualization of the decision tree for allowing management of the executable decision tree and features applied. Another example of visualization of efficacy metrics is illustrated in the sixth screen 706 of FIG. 7B illustrating a user interface component having a tree comparison table and concurrently efficacy valuation graphs including precision recall and ROC curve comparison.

In at least some aspects, the segmentation engine 100 of FIG. 1 applies a machine learning model shown as the machine learning program 105, such that the computerized tool is able to ensure, in at least some aspects, that the end executable decision tree generated on the user interface for dynamic interaction thereafter (e.g. optimized decision tree 107) is the most optimized tree available based on the data set provided (e.g. input data 101, parameter input data 102) as well as the attributes and other characteristics of interest.

In at least some aspects and referring to FIGS. 1-4, the user interface for the segmentation tool 120 generated by the segmentation engine 100, allows users to upload the datasets via one or more associated computing system (e.g. requesting computing systems 110 via screens 115 and the graphical user interface 111 or from another computerized system on the computing environment 150 which contains the needed data such as the electronic data warehouse 119) to be analyzed then curate how the decision tree is to be generated by the decision tree generator module of a customized computing system according to an embodiment, such as by selecting the tree growth method, the depth of the tree or number of leaf nodes, as well as the attributes of interest from a list of all attributes available, thus reducing the chance that an important attribute is overlooked, an example of such a screen view of the user interface is illustrated in the first screen 200 of FIG. 2.

In one implementation and referring to FIGS. 1-10, once the optimized decision tree 107 is generated based on the various inputs (e.g. input data 101 and parameter input data 102 providing the set of parameters such as shown in FIG. 2), the segmentation tool 120 is configured to process the inputs via an input module 103, then perform segmentation of the decision tree via a segmentation module 104 which applies a machine learning program 105, to display and output on the user interface in a way that provides the user with various pieces of important information, including the optimized population splits for each leaf and/or decision node, as well as information via visual graphs about the importance (or lack of importance) and correlations/interrelationships of each attribute chosen, and information about the relative risk of each leaf and/or decision node, such as through the colour-coding of each leaf and decision node as illustrated in FIGS. 8A-8C.

To aid in efficiency, the user-interface generated by the segmentation engine 100 containing the optimized decision tree 107 and set of statistics 108 of FIG. 1 is an interactive UI for display on one or more requesting computing systems 110 as illustrated in FIGS. 2-8A, 8B and 8C and also allows the user of the computing device to utilize the interactive UI to manually adjust the optimized decision tree (e.g. shown as optimized decision tree user input 109), for example by compressing certain decision nodes (decision nodes resulting from the splitting of root nodes as shown in FIG. 8A) upon selection thereof, in order for the end decision-tree to reflect more accurately the types of decisions desired to be made. For example, in FIG. 3, by performing node selection 304 of a particular node on the first decision tree 300 via a screen shown as a second screen 308 on the graphical user interface 111 accessing the segmentation tool 120, e.g. selection of a decision node having node ID: 10, this causes the collapse of the end nodes 306 into its upper level node at node ID: 10, such that the upper level decision node, e.g. node ID 10 becomes the end node. Another example of collapsing via interaction with user interface (UI) elements is shown in FIG. 8A.

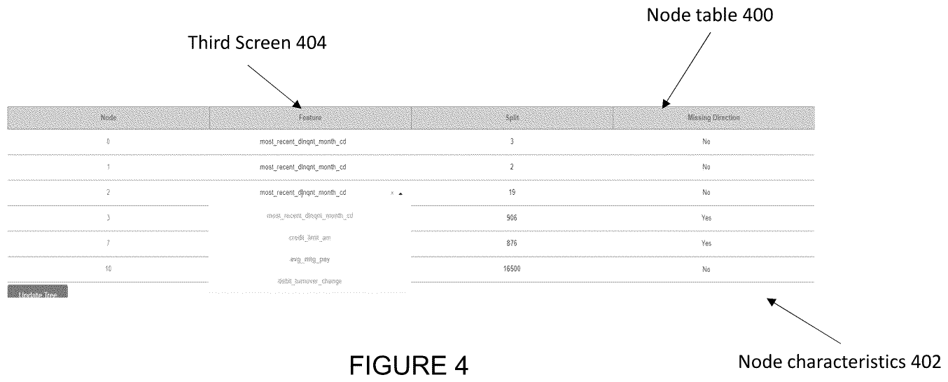

It is noted that while the executable decision tree shown in FIG. 3 and associated FIGS. 2 and 4 generated by the segmentation tool 120 of FIG. 1, relates to financial account data, other implementations may be envisaged as the optimized decision tree 107 generated applies machine learning techniques (e.g. machine learning program 105 applying non-parametric supervised machine learning) for binary or multi-class classification of various other uses. Preferably, the machine learning program 105 used by the segmentation tool 120 applies a type of supervised machine learning used to categorize or predict an outcome based on prior historical knowledge of outcomes and attributes. Further, in at least one aspect, the machine learning program 105 is configured to generate and grow a single XGBoost tree. For example, the machine learning program 105 learns to generate the decision tree by applying a set of training examples provided in training data 117 (which may be accessed from a data repository on the segmentation engine 100 or external thereto) and a set of known outcomes or answers such that the trained machine learning program 105 is able to predict values of outcomes or responses by learning from the decision rules derived from one or more of the features of the input data, e.g. input data 101 having parameter input data 102. The decision tree 107 generated has a hierarchical tree structure including root nodes, branches, internal or decision nodes and leaf or end nodes as shown in FIG. 3.

Thus, in at least some implementations, there is provided a machine learning system and method provided by the segmentation engine 100 of FIG. 1 for providing an interactive and dynamic segmentation tool 120 for analysis of one or more particular features of input data 101 (e.g. risk or likelihood of a particular outcome) using customized and optimal segmentation trees (or decision trees) as generated by the optimized decision tree 107.

An example of feedback inputs (e.g. user input received on the user interface 111 for the segmentation tool 120 of FIG. 1) which can modify the decision tree 107 after it is created includes inputs shown as optimized decision tree user input 109, received directly on a screen of the user interface displaying the decision tree and associated node UI elements (e.g. shown in FIG. 3 or 5) which, upon selection of a particular node, will cause collapsing of specific internal decision nodes, turning the particular node into a leaf or terminal node (bottom node) of the decision tree 107.

Referring to FIGS. 1-8A-8C, another example of inputs received on the segmentation tool 120, whether automatically, semi-automatically or via user input on the user interface, is receiving a selection of a particular node on the decision tree 107 upon determination that the node details (e.g. node details 302) indicate a large number of samples assigned to the node and thereby further segmenting the leaf or end node into further nodes such that the further nodes become the end nodes.

Another example of inputs for the optimized decision tree user input 109 received on the user interface of the segmentation tool 120 which can amend the decision tree 107 after it is created includes inputs to the UI elements depicting the nodes or to the node feature tables displayed on the UI which define how specific internal decision nodes, are split and associated thresholds for splitting, including by changing the populations that are split into its two subsequent leaf and/or decision or internal nodes for revising the decision tree 107. An example screen view is illustrated in the third screen 404 and the associated node table 400 available for editing on the user interface.

Referring again to the schematic block diagram shown in FIG. 1, a computerized machine learning based system shown as a segmentation engine 100 provides a segmentation tool 120 which receives or extracts an input data set, e.g. input data 101 from one or more electronic data warehouses 119 and/or associated requesting computing systems 110, via a computer network 112. The input data set received at the segmentation tool 120 comprises an input data 101 set comprising record data (e.g. account input data 101 in the example of data records relating to transactions between accounts on various computing devices) and associated features and values. The segmentation tool 120 also receives a set of decision tree parameters (e.g. parameter input data 102) related to the generation of the decision tree. Examples of such parameters or fields received are shown in FIG. 2.

In one example, the input data 101 may be associated with one or more data records or accounts held on a data repository or account server in the computing environment of FIG. 1 (e.g. electronic data warehouse 119) for an associated entity.

In the example case of financial transactions for the input data 101, the input data may include but not limited to: account data including attributes pertaining to customer credit data (e.g. debt, mortgage amounts, mortgage payments, mortgage credit limits). Set of parameter input data 102 may generally comprise data pertaining to how the segmentation module 104 may be configured to generate a decision tree such as the optimized decision tree 107, such as the minimum number of samples per leaf or decision node, the tree growth method or algorithm to be used, the maximum number of leaf nodes, the maximum depth for the tree, as well as which attributes pertain to the customer credit data of the accounts to be analyzed by the segmentation tool 120.

In one aspect, the input module 103 collects the input data 101 and set of parameter input data 102. In one example, this may occur via a user-interface of a computerized device associated with the computing device for the segmentation engine 100 and segmentation tool 120, wherein the user interface such as the graphical user interface 111 allows automatically uploading the input data 101 and utilizing the user interface to select at least a portion of available features in the parameter input data 102 as illustrated in the example of FIG. 2.

Once the input module 103 of FIG. 1 has processed the input data, the segmentation module 104 implements a machine-learning program 105 to identify and generate the optimized decision tree 107 and associated decision tree efficiency and generation data included in the statistics 108 data. The optimized decision tree 107 represents the computerized interactive segmentation tree generated for the user interface via the interface module 106 and the machine learning program 105 of the segmentation tool 120. In at least one aspect, the statistics 108 represents data related to the optimized decision tree 107, such as the ranking of importance of the attributes, the correlation of the features to each other, and the contribution or importance of each attribute to the tree (e.g. see example FIGS. 6-7A and 7B).

Referring again to FIGS. 1 and 2-7B, the set of statistics 108 and optimized decision tree 107 is visually displayed to a user through a user interface for the segmentation tool 120 via the interface module 106.

In the example embodiment shown in FIG. 1, the interface module 106 may additionally receive optimized decision tree user input 109 which may occur via the user interface of the computing device (e.g. UI of the segmentation engine 100 and/or requesting computing systems 110) which the decision tree 107 is displayed upon and allows UI requests to collapse or combine selected leaf and/or decision tree nodes of the optimized decision tree 107 visually displayed. Additionally, requests to amend internal decision nodes (e.g. the thresholds which define the splits for the nodes), such as by changing the populations that should be split into its two subsequent leaf and/or decision nodes may be used to further aid in the analysis. This manipulation on the user interface of the segmentation tool 120 causes one or more updated decision trees to be visually generated based on the feedback received.

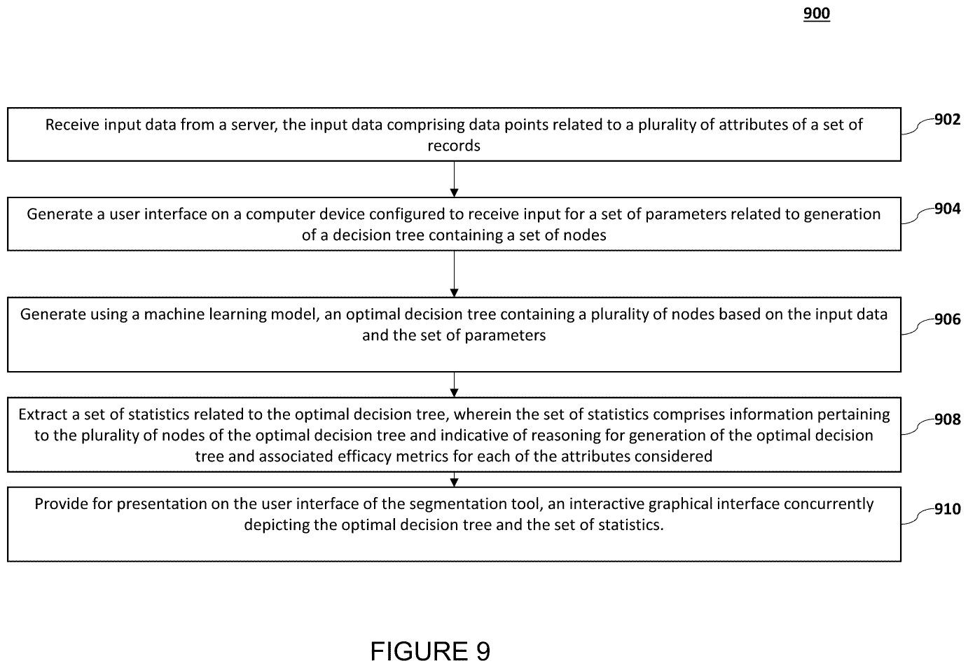

FIG. 9 is a flowchart showing one example of a process flow 900 that may be executed by the segmentation engine 100 of FIG. 1, in an example of generating a segmentation tool using machine learning for providing a user interface for interactive generation of optimized decision trees and updating training of the decision trees based on UI feedback. Example screen shots of the segmentation tool 120 user interface is shown in FIGS. 2-6, 7A-B, 8A-8C. Generally, the segmentation engine 100, may create customized, interactive and dynamic electronic decision trees, wherein a user interface of a computerized device can receive inputs which include both the input data to be analyzed as well as a selection of the various parameters that the engine 100 may use when generating a decision tree.

At operation 902, the segmentation engine 100 of FIG. 1 receives input data from a server (or across the computing environment 150 such as from the electronic data warehouse 119 and/or requesting computing systems 110). The input data may comprise data points and records related to a plurality of attributes of a set of records.

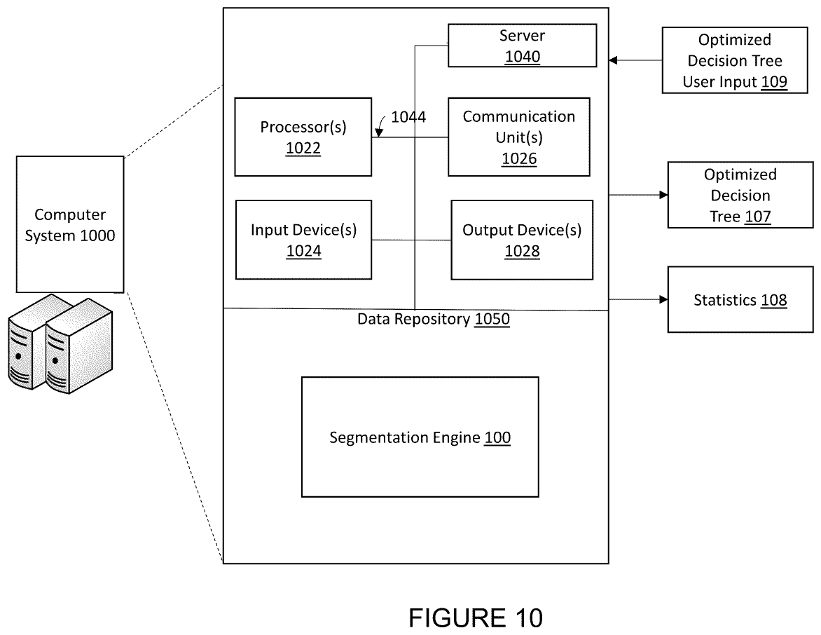

At operation 904, the segmentation engine 100 may generate and display a user interface for a segmentation tool 120 on a computer device (e.g. the device of FIG. 10) configured to receive input for a set of parameters related to generation of a decision tree containing a set of nodes in a hierarchical format.

In various examples, these various parameters and inputs may include (but not limited to): the minimum number of samples that should be divided into each leaf or decision nodes; the segmentation model that the machine learning model uses to generate the output decision tree including an indication on whether the decision tree should be generated using a leaf-wise model or depth-wise model; and the parameters or attributes or features (e.g. see FIG. 2) relevant to the creation of the particular model selected.

The inputs as illustrated in FIG. 2 may further include but not be limited to: the maximum number of leaf nodes that should be generated if a leaf-wise model or the maximum depth in a depth-wise model; and the attributes of the data records that the model should examine in generating the decision tree.

In the specific example where the data records are accounts, the attributes may include but not limited to: the salary deposits, the debt turnover change, the average mortgage payment, etc.

In operation 906, the segmentation engine 100 may generate, using a machine learning model such as the machine learning program 105 implementing supervised learning, an optimal decision tree containing a plurality of nodes based on the input data and the set of parameters. Examples of such decision trees generated for display is shown for example in FIG. 3.

In operation 908, the segmentation engine 100 may further extract a set of statistics related to the optimal decision tree (e.g. see FIGS. 6, 7A-7B), wherein the set of statistics comprises information pertaining to the plurality of nodes of the optimal decision tree and indicative of reasoning for generation of the optimal decision tree (e.g. decision tree 107) and associated efficacy metrics for each of the attributes considered.

In operation 910, the segmentation engine 100 may further provide for presentation on the segmentation tool 120 user interface, an interactive graphical interface concurrently depicting the optimal decision tree and the set of statistics.

Thus, the segmentation tool 120 may transmit these extracted inputs extracted via an input module 103 to a segmentation module 104 which applies a machine-learning model 105 for processing, which will then use the inputs to generate an optimal computerized interactive decision tree 107 while also providing associated decision tree information and associated feature analysis statistics shown as statistics 108 in FIG. 1 and examples of which are shown in FIGS. 6-8C. This display on the segmentation tool 120 user interface may include visual information presented in an interactive and real-time manner associated with features and aspects retrieved from the generated tree. This additional metadata displayed may include but not limited to: the relative importance of each attribute via different graphs such as a ranked graph, a scatterplot, etc.; the correlation of the attributes; the contribution of each attribute; colour-coding the leaf and decision nodes based on risk, etc.

The disclosed system and method comprises, in at least some aspects computerized instructions which, when executed by a specialized processor of a computing device, configure a specific computing device such as the segmentation engine 100 to output and visually display the decision tree 107 (e.g. via graphical user interface 111 of requesting computing systems 110) as well as the information related to it which defines the success of various features selected for the decision tree, decision tree characteristics, etc. on the user interface of the computing device, e.g. the requesting computing systems 110.

Referring to FIGS. 1-9, this computerized visual display of the executable decision tree is dynamic and allows for the interaction, via the user-interface, with the optimized decision tree 107, including inputs shown as the optimized decision tree user input 109 received on the user interface, which will cause the segmentation tool 120 to directly modify the optimized decision tree 107 after it is created to generate updated decision trees in subsequent iterations.

Reference is next made to FIG. 10 which is a diagram illustrating in block form architecture of an example computing device, e.g. a computer system 1000 providing the segmentation engine 100 and for use in the communication system and computing environment 150 of FIG. 1.

The computer system 1000 includes at least one processor 1022 (such as a microprocessor) which controls the operation of the computer system. The processor 1022 is coupled to a plurality of components and computing components via a communication bus or channel, shown as the communication channel 1044,

Computer system 1000 further comprises one or more input devices 1024, one or more communication units 1026, one or more output devices 1028 and one or more servers 1040 or server components. Computer system 1000 also includes one or more data repositories 1050 storing one or more computing modules and components such as the segmentation engine 100 (and in turn the associated components illustrated in FIG. 1 such as but not limited to: input data 101; parameter input data 102; the segmentation tool 120; machine learning program 105; training data 117; optimized decision tree 107; statistics 108 and optimized decision tree user input 109).

Communication channels 1044 may couple each of the components for inter-component communications whether communicatively, physically and/or operatively. In some examples, communication channels 1044 may include a system bus, a network connection, an inter-process communication data structure, or any other method for communicating data.

Referring to FIGS. 1 and 2, one or more processors 1022 may implement functionality and/or execute instructions within the computer system 1000. The processor 1022 is coupled to a plurality of computing components via the communication bus or communication channel 1044 which provides a communication path between the components and the processor 1022. For example, processors 1022 may be configured to receive instructions and/or data from storage devices, e.g. data repository 1050, to execute the functionality of the modules shown in FIG. 2, among others (e.g. operating system, applications, etc.).

Computer system 1000 may store data/information as described herein for the process of performing segmentation using machine learning and decision tree generation on a segmentation user interface which may be delivered to one or more computing devices, such as requesting computing systems 110, by way of interface module 106. Some of the functionality is described further herein.

One or more communication units 1026 may communicate with external devices via one or more networks (e.g. communication network 112) by transmitting and/or receiving network signals on the one or more networks. The communication units may include various antennae and/or network interface cards, etc. for wireless and/or wired communications.

Input devices 1024 and output devices 1028 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 1044).

The one or more data repositories 1050 may store instructions and/or data for processing during operation of the segmentation engine 100. The one or more storage devices may take different forms and/or configurations, for example, as short-term memory or long-term memory. Data repositories 1050 may be configured for short-term storage of information as volatile memory, which does not retain stored contents when power is removed. Volatile memory examples include random access memory (RAM), dynamic random access memory (DRAM), static random access memory (SRAM), etc. Data repositories, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

One or more currently preferred embodiments have been described by way of example. It will be apparent to persons skilled in the art that a number of variations and modifications can be made without departing from the scope of the disclosure as defined in the claims.

1. A computerized method of interactive segmentation analysis, the method comprising:
receiving input data from a server, the input data comprising data points related to a plurality of attributes of a set of records;
generating a user interface on a computer device configured to receive input for a set of parameters related to a generation of a decision tree containing a set of nodes, the set of parameters comprising:
a computerized algorithm to employ in creating the decision tree;
constraints pertaining to the algorithm selected comprising selecting the maximum number of leaf nodes if leaf-wise is selected, or selecting the maximum depth if depth-wise is selected;
a minimum number of records to be divided into each node of the decision tree; and
a set of attributes for consideration by the decision tree from the plurality of attributes contained in the input data;
generating, using a machine learning model, an optimal decision tree containing a plurality of nodes based on the input data and the set of parameters;
extracting a set of statistics related to the optimal decision tree, wherein the set of statistics comprises information pertaining to the plurality of nodes of the optimal decision tree and indicative of reasoning for generation of the optimal decision tree and associated efficacy metrics for each of the attributes considered; and
providing, for presentation on the user interface, an interactive graphical interface concurrently depicting the optimal decision tree and the set of statistics.

2. The method of claim 1, wherein the algorithm comprises at least one of: a tree growth model, depth-wise, and leaf-wise tree generation modes.

3. The method of claim 1, wherein the optimal decision tree presented on the graphical interface is further configured to receive inputs from a user to alter the optimal decision tree presented on the graphical interface.

4. The method of claim 3, wherein the inputs to alter the optimal decision tree on the graphical interface includes user interface requests received directly on the decision tree nodes generated on the user interface to combine sub-nodes of a node within the optimal decision tree presented on the graphical interface, via regeneration of the optimal decision tree by the machine learning model.

5. The method of claim 3, wherein the inputs to alter the optimal decision tree presented on the graphical interface includes user interface requests to alter a manner in which a particular node of the optimal decision tree divides into its sub-nodes, via regeneration of the optimal decision tree by the machine learning model.

6. The method of claim 5, wherein the inputs to alter presentation of the particular node of the optimal decision tree on the graphical interface divides into its sub-nodes includes altering the number of samples divided into each of the sub-nodes via regeneration of the optimal decision tree by the machine learning model.

7. The method of claim 3, wherein the inputs to alter the optimal decision tree on the graphical interface comprise a user interface menu to allow custom splitting of a selected node of the optimal decision tree to create two new leaf nodes from the selected node which then represents an internal node.

8. The method of claim 3, wherein the input to alter the optimal decision tree on the graphical interface further comprise a user interface menu to graft a first tree onto a second tree via selection and dragging one tree displayed on the user interface onto another thereby causing regeneration of the optimal decision tree including the first and the second tree.

9. The method of claim 1, wherein the machine learning model is a supervised machine learning model trained on a set of known outcomes and known attributes to generate the optimized decision tree from the set of parameters.

10. The method of claim 9, wherein the machine learning model is an xGBoost model.

11. A system comprising a computer having at least one processor and a non-transient storage medium storing computer readable instructions, that when executed by said at least one processor of the computer, cause the computer to perform operations comprising:
receiving input data from a server, the input data comprising data points related to a plurality of attributes of a set of records;
generating a user interface on a computer device configured to receive input for a set of parameters related to a generation of a decision tree containing a set of nodes, the set of parameters comprising:
a computerized algorithm to employ in creating the decision tree;
constraints pertaining to the algorithm selected comprising selecting the maximum number of leaf nodes if leaf-wise is selected, or selecting the maximum depth if depth-wise is selected;
a minimum number of records to be divided into each node of the decision tree; and
a set of attributes for consideration by the decision tree from the plurality of attributes contained in the input data;
generating, using a machine learning model, an optimal decision tree containing a plurality of nodes based on the input data and the set of parameters;
extracting a set of statistics related to the optimal decision tree, wherein the set of statistics comprises information pertaining to the plurality of nodes of the optimal decision tree and indicative of reasoning for generation of the optimal decision tree and associated efficacy metrics for each of the attributes considered; and
providing, for presentation on the user interface, an interactive graphical interface concurrently depicting the optimal decision tree and the set of statistics.

12. The system of claim 11, wherein the algorithm comprises at least one of: a tree growth model, depth-wise, and leaf-wise tree generation modes.

13. The system of claim 11, wherein the optimal decision tree presented on the graphical interface is further configured to receive inputs from a user to alter the optimal decision tree presented on the graphical interface.

14. The system of claim 13, wherein the inputs to alter the optimal decision tree on the graphical interface includes user interface requests received directly on the decision tree nodes generated on the user interface to combine sub-nodes of a node within the optimal decision tree presented on the graphical interface, via regeneration of the optimal decision tree by the machine learning model.

15. The system of claim 13, wherein the inputs to alter the optimal decision tree presented on the graphical interface includes user interface requests to alter a manner in which a particular node of the optimal decision tree divides into its sub-nodes, thereby the instructions causing operations comprising regeneration of the optimal decision tree by the machine learning model.

16. The system of claim 15, wherein the inputs to alter presentation of the particular node of the optimal decision tree on the graphical interface divides into its sub-nodes includes altering the number of samples divided into each of the sub-nodes thereby the instructions causing operations comprising regeneration of the optimal decision tree by the machine learning model.

17. The system of claim 13, wherein the inputs to alter the optimal decision tree on the graphical interface comprise a user interface menu to allow custom splitting of a selected node of the optimal decision tree to create two new leaf nodes from the selected node which then represents an internal node.

18. The system of claim 13, wherein the input to alter the optimal decision tree on the graphical interface further comprise a user interface menu to graft a first tree onto a second tree via selection and dragging one tree displayed on the user interface onto another thereby the instructions causing operations comprising regeneration of the optimal decision tree including the first and the second tree.

19. The system of claim 11, wherein the machine learning model is a supervised machine learning model trained on a set of known outcomes and known attributes to generate the optimized decision tree from the set of parameters.

20. The system of claim 19, wherein the machine learning model is an xGBoost model.

21. A non-transitory machine-readable medium comprising instruction thereon that, when executed by a processor unit, causes the processor unit to perform operations comprising:
receiving input data from a server, the input data comprising data points related to a plurality of attributes of a set of records;
generating a user interface on a computer device configured to receive input for a set of parameters related to a generation of a decision tree containing a set of nodes, the set of parameters comprising:
a computerized algorithm to employ in creating the decision tree;
constraints pertaining to the algorithm selected comprising selecting the maximum number of leaf nodes if leaf-wise is selected, or selecting the maximum depth if depth-wise is selected;
a minimum number of records to be divided into each node of the decision tree; and
a set of attributes for consideration by the decision tree from the plurality of attributes contained in the input data;
generating, using a machine learning model, an optimal decision tree containing a plurality of nodes based on the input data and the set of parameters;
extracting a set of statistics related to the optimal decision tree, wherein the set of statistics comprises information pertaining to the plurality of nodes of the optimal decision tree and indicative of reasoning for generation of the optimal decision tree and associated efficacy metrics for each of the attributes considered; and
providing, for presentation on the user interface, an interactive graphical interface concurrently depicting the optimal decision tree and the set of statistics.
